(19) United States
(12) Patent Application Publication
(10) Pub. No.: US 2011/0273055 A1
(43) Pub. Date: Nov. 10, 2011

(54) Method and Apparatus for Retaining Laminations of a Stator of an Electrical Machine

(75) Inventor: Wayne A. Pengov, Chardon, OH (US)

(73) Assignee: BALDOR ELECTRIC COMPANY, Fort Smith, AR (US)

(21) Appl. No.: 12/775,050

(22) Filed: May 6, 2010

(51) Int. Cl. H02K 1/18

(52) U.S. Cl. 310/216.132

(57) ABSTRACT

A retainer in the stator of an electrical machine holds a plurality of stacked stator laminations in compression at an inner diameter of a stator core. The plurality of laminations have a central aperture and a plurality of teeth circumferentially spaced about the central aperture. The plurality of stacked laminations forms a contiguous stator core with a central aperture for housing a rotor and stator winding slots extending from one axial face of the stator core to an opposite axial face of the stator core. The retainer is adapted to be fitted in the stator slots adjacent the windings and adjacent the central aperture. The retainer extends from one axial face of the stator core to the opposite axial face of the stator core. The retainer has opposite longitudinal ends abutting the axial opposite faces of the stator core that hold the laminations in compression.

### BACKGROUND

The disclosure relates generally to the field of electric motors and generators and, particularly, to the construction of stators for such motors and generators.

### DESCRIPTION OF THE DRAWINGS

FIG. 1 is a partial cross-sectional view of an electric motor;

FIG. 2 is partial cross-sectional view of a stator core of the electric motor taken along section 2-2 of FIG. 1;

FIG. 3 is partial cross-sectional view of the stator core of the electric motor taken along section 3-3 of FIG. 1 and represents a view opposite that of FIG. 2;

FIG. 4 is a side view of a clip comprising a retainer assembly;

FIG. 5 is a perspective view of the retainer assembly of FIG. 4;

FIG. 6 is a partial cross-sectional view of the motor taken along section 6-6 of FIG. 1;

FIG. 7 is partial cross-sectional view of the motor with detailed areas showing the configuration of the retainer assembly.

### DETAILED DESCRIPTION

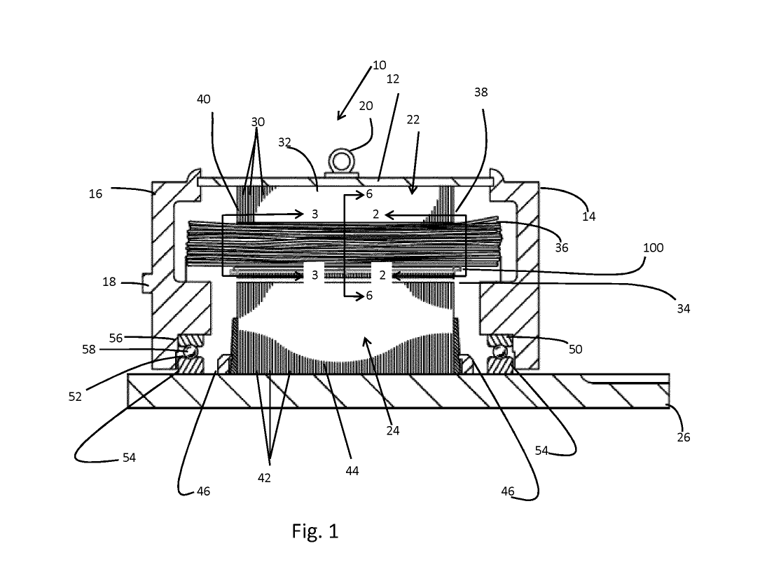

Electric motors of various types are commonly found in industrial, commercial, and consumer settings. In industry, such motors are employed to drive various kinds of machinery, such as pumps, conveyors, compressors, fans and so forth, to mention only a few. Turning to the drawings, FIG. 1 illustrates an exemplary electric motor 10. To simplify the discussion, only the top portion of the motor 10 is shown, as the structure of the motor 10 is essentially mirrored along its centerline. In the embodiment illustrated, the motor 10 comprises a switched reluctance motor housed in a motor housing. However, the principles disclosed herein may also be used with other motors and generators, for instance, induction motors or permanent magnet motors. The exemplary motor 10 comprises a frame 12 capped at each end by front and rear end caps 14,16, respectively. The frame 12 and the front and rear end caps 14,16 cooperate to form the enclosure or motor housing for the motor. The frame 12 and the front and rear end caps 14,16 may be formed of any number of materials, such as steel, aluminum, or any other suitable structural material. The end caps 14,16 may include mounting and transportation features, such as the illustrated mounting flange 18 and eyehook 20. Those skilled in the art will appreciate in light of the following description that a wide variety of motor configurations and devices may employ the construction techniques outlined below.

Within the frame 12, there are a stator 22 and rotor 24. Rotation of the rotor is effected by routing current through the stator. A rotor shaft 26 coupled to the rotor rotates in conjunction with the rotor. That is, rotation of the rotor translates into a corresponding rotation of the rotor shaft 26. As appreciated by those of ordinary skill in the art, the rotor shaft 26 may couple to any number of drive machine elements, thereby transmitting torque to the given drive machine element. By way of example, machines such as pumps, compressors, fans, conveyors, and so forth, may harness the rotational motion of the rotor shaft 26 for operation.

The stator 22 comprises a plurality of stator laminations 30 juxtaposed and aligned with respect to one another to form a lamination stack, such as a contiguous stator core 32. In the exemplary motor 10, the stator laminations 30 are substantially identical to one another, and each includes features that cooperate with adjacent laminations to form cumulative features for the contiguous stator core 32. For example, each stator lamination 30 includes a central aperture that cooperates with the central aperture of adjacent laminations to form a rotor chamber 34 that extends the length of the stator core 32 and that is sized to receive the rotor. Additionally, each stator lamination 30 includes a plurality of stator slots disposed circumferentially about the central aperture. These stator slots cooperate to receive two or more stator windings 36, which are illustrated as coil sides in FIG. 1, that extend the length of the stator core 32 from a first axial face 38 to an opposite axial face 40. The stator laminations of an electrical machine such as a switch reluctance motor may be held together with a weld bead 41 extending axially on the outer diameter of the contiguous stator core 32.

The rotor 24 resides within the rotor chamber 34. Similar to the stator core 32, the rotor 24 comprises a plurality of rotor laminations 42 aligned and adjacently placed with respect to one another. Thus, the rotor laminations 42 cooperate to form a contiguous rotor core 44. The exemplary rotor 24 also includes an end plate assembly 46, disposed on each end of the rotor core 44, that cooperates to secure the rotor laminations 42 with respect to one another. When assembled, the rotor laminations 42 cooperate to form a shaft chamber that extends through the center of the rotor core 44 and that is configured to receive the rotor shaft 26 therethrough. The rotor shaft 26 is secured with respect to the rotor core 44 such that the rotor core 44 and the rotor shaft 26 rotate as a single entity—the rotor 24.

To support the rotor, the exemplary motor 10 includes front and rear bearing sets 50, 52, respectively, that are secured to the rotor shaft 26 and that facilitate rotation of the rotor within the stationary stator core 32. During operation of the motor 10, the bearing sets 50, 52 facilitate transfer of the radial and thrust loads produced by the rotor to the motor housing. Each bearing set 50,52 includes an inner race 54 disposed circumferentially about the rotor shaft 26. The tight fit between the inner race 54 and the rotor shaft 26 causes the inner race 54 to rotate in conjunction with the rotor shaft 26. Each bearing set 50, 52 also includes an outer race 56 and ball bearings 58, which are disposed between the inner and outer races 54, 56. The ball bearings 58 facilitate rotation of the inner races 54 while the outer races 56 remain stationary and mounted with respect to the end caps 14,16. Thus, the bearing sets 50, 52 facilitate rotation of the rotor while supporting the rotor within the motor housing, i.e., the frame 12 and the end caps 14,16. To reduce the coefficient of friction between the races 54,56 and the ball bearings 58, the ball bearings may be coated with a lubricant.

To maintain the stator laminations in compression at the stator tooth tips, a retainer 100 is used. As will be explained below in greater detail, the retainer 100 may be fitted in the stator slots adjacent the windings to hold the stack of laminations of the contiguous stator core 32 in compression at the stator tooth tips. Thus, the retainer 100 together with the axial weld bead 41, or other outer diameter fixation means, provide improved structural integrity for the stator 22.

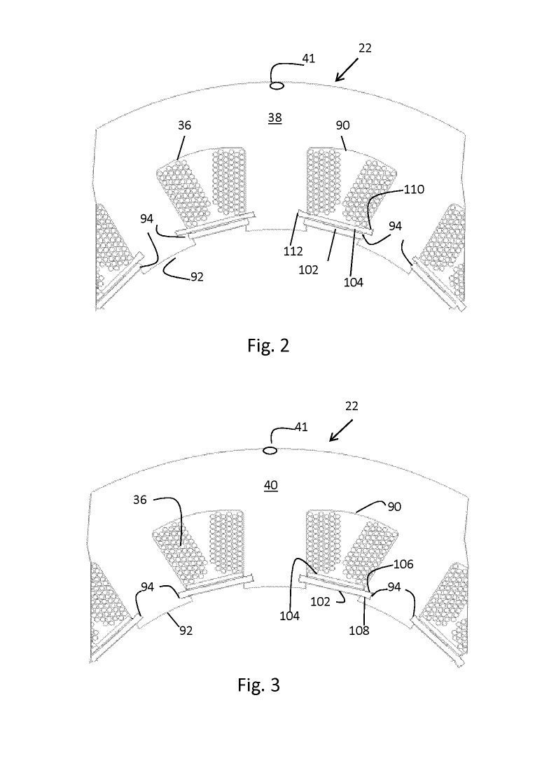

FIGS. 2-7 show the retainer or clip 100. Preferably, the retainer or clip 100 comprises a non-conductive, structurally rigid material with a high shear strength. The retainer preferably comprises an assembly with a first retainer portion 102 and a second retainer portion 104. The first retainer portion 102 comprises an elongated strip of material generally rectangular in shape with a face capturing surface 106 on an axial end 108. The second retainer portion 104 also comprises a rectangular elongated strip of material with a face capturing surface 110 on its axial end 112. Preferably, the first and second retainer portions 102, 104 have interlocking features that enable the first and second portions to be assembled together to form a retainer assembly with the face capturing surface 110 of the second retainer portion 104 longitudinally opposite the face capturing surface 106 of the first retainer portion 102.

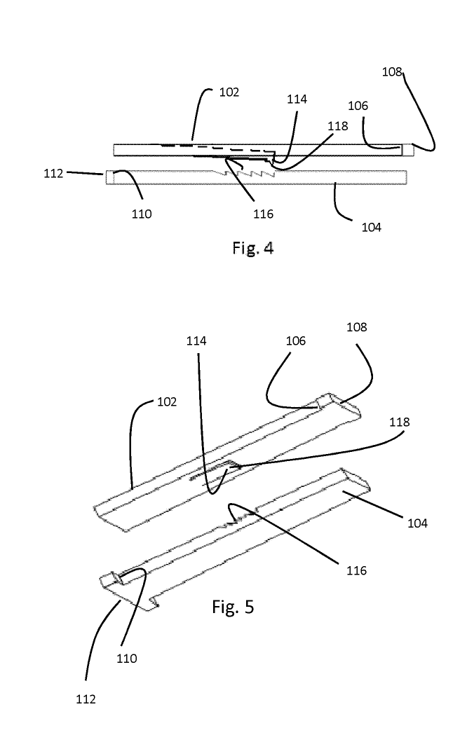

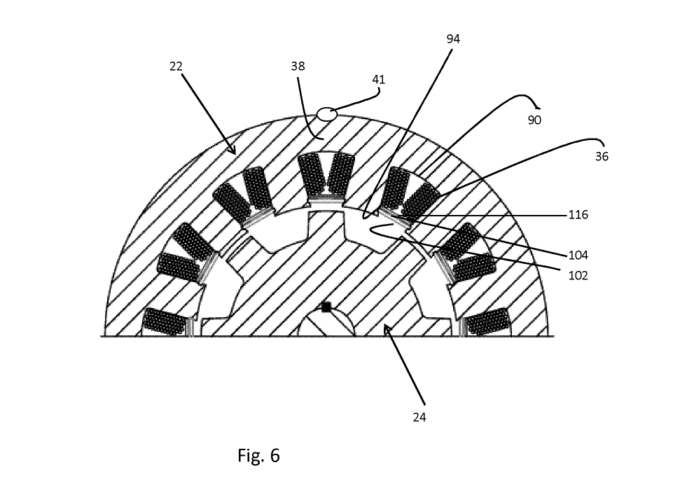

As best shown in FIGS. 4 and 5, the first retainer portion 102 and second retainer portion 104 may be interlocked together to form the assembly with a notch and detent arrangement. The first retainer portion 102 preferably has a rectangular tab 114 which is punched through the mid section of the elongated section and deflected (downward in FIGS. 4 and 5) so as to project from the mid section (bottom in FIGS. 4 and 5) of the first retainer portion. The second retainer portion 104 is formed with a plurality of serrations 116 extending across its width at its mid section (top in FIGS. 4 and 5) that cooperate with the tab 114 formed in the first retainer portion to lock the assembly together. The distal end of the tab 114 is formed into a tip 118 that cooperates with the serrations 116. The interlocking features may reversed between the first and second retainer portions, and instead of a tab and serrations, may comprise a system of cooperating tabs and slots, nubs and holes, etc.

During installation, the second retainer portion 104 is received in the stator slot 90 adjacent the windings 36 and preferably toward or adjacent the distal end of adjacent stator teeth 92 with the second retainer portion face capturing surface 110 engaging the axial face 38 of the stator core. The second retainer portion 104 may abut the windings 36 extending through the stator slot 90. The first retainer portion 102 is received in the stator slot 90 adjacent the second retainer portion 104 preferably closer in distance toward the central aperture 34 than the second retainer portion and adjacent the distal end of adjacent stator teeth 92. The first retainer portion 102 may then be moved axially relative to the stator core centerline such that the first retainer portion face capturing surface 106 engages the opposite axial face 40 of the stator. As the first retainer portion 102 is moved into position, the serrations 116 of the second retainer portion engage the first retainer portion tab 114, locking the assembly with the first retainer portion face capturing surface 106 engaging one axial face 40 of the stator and the second retainer portion face capturing surface 110 engaging the opposite axial face 38 of the stator. By providing a plurality of rows serrations 116, the length of the retainer assembly may be adjusted as necessary to accommodate variations in manufacturing tolerances in the axial dimension of the contiguous stator core. The clip or retainer may also be formed monolithically at a dimension that enables the face capturing surfaces of the retainer to abut the axial opposite faces of the stator to hold the stator laminations in compression. The configuration may also be reversed among the first and second retainer portions.

In some constructions of electrical machine stators, such as that shown in FIGS. 2 and 3, the distal end of each stator tooth 92 has a notch 94 to provide a locating surface for a stator slot insulator. The retainer 100 may cooperate with the pattern of notches 94 at the distal end of each stator tooth 94 to assist in maintaining the retainer 100 in the stator slot 90. For instance, for retainer or clip 100 comprising an assembly, the first and second portions may be configured so that the first retainer portion 102 may fit within the existing pattern of notches 94 provided on the distal end of each stator tooth 92. The second retainer portion 104 may have a width less than a stator slot width dimension at the distal end of each stator tooth, thereby allowing the second retainer portion to fit within the stator slot immediately adjacent the first retainer portion fitted in the stator tooth tip notches. The generally narrowing of the stator slot at the distal end of the stator teeth also allows the retainer to be fitted in the stator slot, with or without the use of a stator slot insulator, with or without the notches, and with or without force from the windings pushing the retainer against the opposing walls of the stator slot. Force from the windings may be used to assist in maintaining the first and second portions of the retainer assembly in a locked configuration.

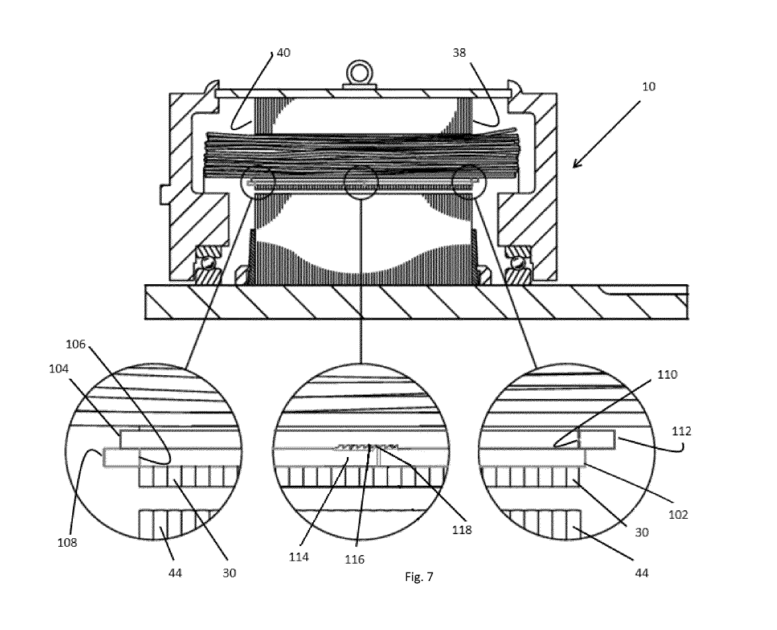

As best shown in FIGS. 6 and 7, a retainer (i.e., clip) or retainer assembly may be fitted in one or more of the slots of the stator to hold a stator stack in compression at the stator tooth tips. The retainer may comprise a slot insulator. Combined with the weld extending on the outer diameter of the stator core, the stator stack may be held in compression around its complete periphery, thereby preventing teeth from flaring outward during final assembly or operation of the motor.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed were meant to be illustrative only and not limited as to the scope of the invention which is to be given the full breadth of the appended claims and any equivalents thereof.

What is claimed is:

1. A retainer for a stator of an electrical machine wherein the stator comprises a plurality of laminations assembled in a stack to form a contiguous stator core, the core having a center line and axial opposite faces defining a plane perpendicular to the center line, the contiguous stator core having a plurality of slots parallel to the center line extending between the axial faces, the plurality of slots being adapted to receive windings of the stator, the retainer comprising:
a clip corresponding substantially to an axial length of the stator core, the clip being dimensioned to be received within at least one of the stator core slots with opposite longitudinal ends of the clip abutting the axial faces of the stator core and holding the stator core laminations in compression when the clip is received in the stator core slots.

2. The retainer of claim 1 wherein the clip comprises an assembly with a first portion securable to a second portion in a manner so as to vary a longitudinal length dimension of the clip and enable the clip longitudinal ends to abut the axial outer faces of the stator core.

3. The retainer of claim 1 wherein one of the first and second portions of the clip assembly comprises a plurality of serrations and the other of the first and second portions of the clip assembly comprises a tab that cooperates with the serrations to adjustably secure the first and second portions together to form the clip assembly.

4. An electrical machine comprising:
a plurality of laminations having a central aperture and a plurality of teeth circumferentially spaced about the central aperture, the plurality of laminations being arranged in a stack to form a contiguous stator core with the central aperture of each of the laminations being aligned to form a hollow center for housing a rotor of the electrical machine and the plurality of stator teeth being aligned to define stator slots extending from one axial face of the stator core to an opposite axial face of the stator core, the slots containing wires for the stator core; and
a retainer fitted in the stator slots adjacent the windings and adjacent the central aperture, the retainer extending from one axial face of the stator core to the opposite axial face of the stator core, the retainer having opposite longitudinal ends abutting the axial opposite faces of the stator core and holding the laminations of the stator core in compression.

5. The electrical machine of claim 4, wherein the retainer is disposed between adjacent stator teeth of the stator core.

6. The electrical machine of claim 5, wherein distal ends of adjacent stator teeth have notches and at least a portion of the retainer is received in the notches.

7. The electrical machine in claim 6, wherein the retainer comprises first and second portions adjustably secured together to form a retainer assembly.

8. The electrical machine of claim 7 wherein one of the first and second portions of the retainer assembly is received in the notches of adjacent stator teeth.

9. The electrical machine of claim 8, wherein the other of the first and second portions of the retainer assembly is received in the stator slot adjacent the stator windings.

10. The electrical machine of claim 7, wherein one of the first and second portions of the retainer assembly has serrations and the other of the first and second portions of the retainer assembly has a tab that cooperates with the serrations to lock the first and second portions together to form the retainer assembly.

11. The electrical machine in claim 4, wherein the retainer comprises first and second portions adjustably secured together to form a retainer assembly.

12. The electrical machine of claim 11 wherein one of the first and second portions of the retainer assembly has serrations and the other of the first and second portions of the retainer assembly has a tab that cooperates with the serrations to lock the first and second portions together to form the retainer assembly.

13. A method comprising:
arranging a plurality of laminations in a stack, each of the laminations having a central aperture and a plurality of teeth circumferentially spaced about the central aperture, the arranged stack of laminations forming a contiguous stator core with the central aperture of each of the laminations being aligned to form a hollow center for housing a rotor of the electrical machine and the plurality of stator teeth being aligned to define stator slots extending from one axial face of the stator core to an opposite axial face of the stator core; and
fitting a retainer in the stator slots adjacent the windings and adjacent the central aperture so that the retainer extends from one axial face of the stator core to the opposite axial face of the stator core, and so that opposite longitudinal ends of the retainer abut the axial opposite faces of the stator core and hold the laminations of the stator core in compression.

14. The method of claim 13, wherein the step of fitting the retainer includes disposing the retainer between adjacent stator teeth of the stator core.

15. The method of claim 14, wherein distal ends of adjacent stator teeth have notches, and wherein the step of fitting the retainer includes disposing at least a portion of the retainer in the notches.

16. The method of claim 15, wherein the retainer comprises first and second portions with interlocking features that allow the first and second portions to be adjustably securable together, and wherein the step of fitting the retainer includes securing the first and second portions together to form a retainer assembly.

17. The method of claim 16, wherein the step of fitting the retainer includes fitting one of the first and second portions of the retainer assembly in the notches of adjacent stator teeth.

18. The method of claim 17, wherein the step of fitting the retainer includes fitting the other of the first and second portions of the retainer assembly in the stator slot adjacent the stator windings.

19. The method of claim 16, wherein one of the first and second portions of the retainer assembly has serrations and the other of the first and second portions of the retainer assembly has a tab that cooperates with the serrations, and the step of fitting the retainer includes locking the first and second portions together to form the retainer assembly.

20. The method of claim 13, wherein the retainer comprises first and second portions with interlocking features that allow the first and second portions to be adjustably securable together, and wherein the step of fitting the retainer includes securing the first and second portions together to form a retainer assembly.
